(19) United States
(12) Patent Application Publication
(10) Pub. No.: US 2011/0190031 A1
(43) Pub. Date: Aug. 4, 2011

(54) RECEIVER, RADIO BASE STATION AND RECEPTION METHOD

(75) Inventors: Eugen Pfann, Linz (AT); Fangwei Tong, Yokohama-shi (JP)

(73) Assignee: Kyocera Corporation, Kyoto (JP)

(21) Appl. No.: 12/745,527

(22) PCT Filed: Nov. 28, 2008
(86) PCT No.: PCT/JP2008/071670

§ 371 Date: Oct. 14, 2010

(30) Foreign Application Priority Data
Nov. 29, 2007 (JP) 2007-309496

(51) Int. Cl. H04W 88/08; H04W 88/02

(52) U.S. Cl. 455/561; 455/269

(57) ABSTRACT

A weight calculator (140) of a receiver (10) comprises an antenna weight processor (140A) and an equalization weight processor (140B). The antenna weight processor (140A) sets the initial values of antenna weights (w*₁ to w*_{R}) to an antenna weighting unit (115). The equalization weight processor (140B) calculates equalization weights (c*₀ to c*_{M}) by using an optimization algorithm in the state in which the initial values are held in the antenna weighting unit (115). The antenna weight processor (140A) calculates the antenna weights (w*₁ to w*_{R}) by using the optimization algorithm in the state in which the calculated equalization weights (c*₀ to c*_{M}) are held in a feed-forward unit (120A).

### TECHNICAL FIELD

The present invention relates to a receiver, a radio base station, and a reception method which use an adaptive array antenna and an adaptive equalizer.

### BACKGROUND ART

In recent years, a receiver using an adaptive array antenna and an adaptive equalizer has been used in a radio communication system in order to improve reception quality.

The adaptive array antenna is capable of increasing antenna gain for a desired wave and also decreasing antenna gain for an interference wave. Specifically, the adaptive array antenna has an array antenna including multiple antenna elements, and an antenna weighting unit configured to weight reception signals by using antenna weights, the reception signals received by the array antenna.

The adaptive equalizer combines a preceding wave and a delay wave of the desired wave while matching the phases thereof, the preceding wave received first and the delay wave received later. The adaptive equalizer is thereby capable of correcting (equalizing) a signal distorted due to a multipath propagation environment. Specifically, the adaptive equalizer delays a reception signal multiple times, and also weights each of the resultant reception signals thus delayed by using an equalization weight.

Meanwhile, there is known a receiver having a configuration in which the adaptive equalizer is series-connected to an output of the aforementioned adaptive array antenna (Patent Document 1, for example). The receiver described in Patent Document 1 includes a weight calculator configured to collectively calculate an antenna weight and an equalization weight by use of an optimization algorithm.

The weight calculator described in Patent Document 1 collectively calculates an antenna weight and an equalization weight by use of an optimization algorithm such as LMS or RLS, which minimizes the mean square error between an output signal of the adaptive equalizer and a predetermined reference signal. Patent Document 1: JP-A 2002-261669 (Paragraphs [0013] to [0040], FIG. 1)

### DISCLOSURE OF THE INVENTION

Here, in the configuration in which the adaptive equalizer is series-connected to the output of the adaptive array antenna, the state of a reception signal inputted to the adaptive equalizer changes in accordance with the antenna weight set by the antenna weighting unit.

Specifically, in order to calculate an equalization weight by use of the optimization algorithm, the state of the reception signal inputted to the adaptive equalizer needs to be kept unchanged by determining an antenna weight first. Likewise, in order to calculate an antenna weight by use of the optimization algorithm, the characteristics of the adaptive equalizer need to be kept unchanged by determining an equalization weight first.

In the technique of Patent Document 1, however, the weight calculator collectively calculates an antenna weight and an equalization weight. Accordingly, there arises a concern that each of the antenna weight and the equalization weight may not converge, and thus the antenna weight and the equalization weight cannot be properly calculated.

Hence, the present invention has been made to solve the problem described above, and an objective of the present invention is to provide a receiver, a radio base station, and a reception method which allow properly calculating an antenna weight and an equalization weight by use of an optimization algorithm even with the configuration in which an adaptive equalizer is series-connected to an output of an adaptive array antenna.

A first aspect of the present invention is summarized as a receiver (receiver 10) comprising: an array antenna (array antenna 111) having a plurality of antenna elements (antenna elements ANT₁ to ANT_{R}); an antenna weighting unit (antenna weighting unit 115) configured to weight reception signals received by the array antenna; an adaptive equalizer (feedforward unit 120A) configured to equalize the reception signals weighted by the antenna weighting unit; and a weight calculator (weight calculator 140) configured to calculate an antenna weight (antenna weights w*₁ to w*_{R} (*: complex conjugate)) to be set in the antenna weighting unit and an equalization weight (equalization weights c*₀ to c*_{M} (*: complex conjugate)) to be set in the adaptive equalizer in accordance with an error (error signal e[k]) between an output signal (output signal y[k]) from the adaptive equalizer and a predetermined reference signal (reference signal d[k]), wherein the weight calculator comprises: an initial value setting unit (antenna weight processor 140A) configured to set an initial value of the antenna weight in the antenna weighting unit; a first equalization weight calculator (equalization weight processor 140B) configured to calculate the equalization weight by use of an optimization algorithm minimizing the error in a state where the initial value is retained in the antenna weighting unit; an antenna weight calculator (antenna weight processor 140A) configured to calculate the antenna weight by use of the optimization algorithm in a state where the equalization weight calculated by the first equalization weight calculator is retained in the adaptive equalizer; and a second equalization weight calculator (equalization weight processor 140B) configured to calculate the equalization weight by use of the optimization algorithm in a state where the antenna weight calculated by the antenna weight calculator is retained in the antenna weighting unit.

According to the aforementioned aspect, the weight calculator alternatively calculates an antenna weight and an equalization weight instead of collectively calculating the antenna weight and the equalization weight. In other words, it is possible to set the antenna weight not to change at the time of calculating the equalization weight and also to set the equalization weight not to change at the time of calculating the antenna weight. Accordingly, it is possible to provide the receiver that is capable of properly calculating an antenna weight and an equalization weight by use of the optimization algorithm even with the configuration in which the adaptive equalizer is series-connected to an output of the adaptive array antenna.

A second aspect of the present invention is summarized as the radio communication device according to the first aspect of the present invention, wherein the antenna weight calculator calculates the antenna weight by use of the optimization algorithm in a state where the equalization weight calculated by the second equalization weight calculator is retained in the adaptive equalizer, the second equalization weight calculator iteratively calculates the equalization weight until the number of calculations reaches a predetermined number of times (required number of repetitions lₘₐₓ), and the antenna weight calculator iteratively calculates the antenna weight until the number of calculations reaches a predetermined number of times (required number of repetitions lₘₐₓ).

A third aspect of the present invention is summarized as the radio communication device according to the first aspect of the present invention, further comprising: a threshold comparator (termination condition determination unit 140C) configured to compare the error with a threshold; and a calculation termination unit (termination condition determination unit 140C) configured to terminate the calculation of the antenna weight in the weight calculator and the calculation of the equalization weight in the weight calculator when the error becomes lower than the threshold.

A fourth aspect of the present invention is summarized as the radio communication device according to the first aspect of the present invention, further comprising: a first detector (termination condition determination unit 140C) configured to detect a first error decrease amount by which the error is decreased because the antenna weight is set in the antenna weighting unit; a second detector (termination condition determination unit 140C) configured to detect a second error decrease amount by which the error is decreased because the equalization weight is set in the adaptive equalizer; and a calculation terminating unit (termination condition determination unit 140C) configured to terminate the calculation of the antenna weight in the weight calculator and the calculation of the equalization weight in the weight calculator when any one of the first error decrease amount and the second error decrease amount becomes lower than a predetermined amount.

A fifth aspect of the present invention is summarized as the radio communication device according to the first aspect of the present invention, further comprising a fixed value setting unit (antenna weight processor 140A or equalization weight processor 140B) configured to set as a fixed value (fixed value C*_{c} or C*_{W} (*: complex conjugate)) any one (weight value w*_{B} (*: complex conjugate)) of a plurality of weight values forming the antenna weight; or anyone (weight value c*_{B} (*: complex conjugate)) of a plurality of weight values forming the equalization weight, before the initial value is set.

A sixth aspect of the present invention is summarized as the radio communication device according to the first aspect of the invention, wherein the initial value setting unit calculates the initial value of the antenna weight by use of the optimization algorithm in a state where an output signal of the antenna weighting unit passes through the adaptive equalizer without being processed, and then sets the calculated initial value in the antenna weighting, unit.

A seventh aspect of the present invention is summarized as a receiver comprising: an array antenna having a plurality of antenna elements; an antenna weighting unit configured to weight reception signals received by the array antenna; an adaptive equalizer configured to equalize the reception signals weighted by the antenna weighting unit; and a weight calculator configured to calculate an antenna weight to be set in the antenna weighting unit and an equalization weight to be set in the adaptive equalizer in accordance with an error between an output signal from the adaptive equalizer and a predetermined reference signal, wherein the weight calculator comprises: an initial value setting unit (equalization weight processor 140B) configured to set an initial value of the equalization weight in the adaptive equalizer; a first antenna weight calculator (antenna weight processor 140A) configured to calculate the antenna weight by use of an optimization algorithm minimizing the error in a state where the initial value is retained in the adaptive equalizer; an equalization weight calculator (equalization weight processor 140B) configured to calculate the equalization weight by use of the optimization algorithm in a state where the antenna weight calculated by the first antenna weight calculator is retained in the antenna weighting unit; and a second antenna weight calculator (antenna weight processor 140A) configured to calculate the antenna weight by use of the optimization algorithm in a state where the equalization weight calculated by the equalization weight calculator is retained in the adaptive equalizer.

An eighth aspect of the present invention is summarized as a radio base station comprising the receiver according to any one of the first to seventh aspects.

A ninth aspect of the present invention is summarized as a reception method using: an array antenna having a plurality of antenna elements; an antenna weighting unit configured to weight reception signals received by the array antenna; an adaptive equalizer configured to equalize the reception signals weighted by the antenna weighting unit; and a weight calculator configured to calculate an antenna weight to be set in the antenna weighting unit and an equalization weight to be set in the adaptive equalizer in accordance with an error between an output signal from the adaptive equalizer and a predetermined reference signal, the method comprising: an initial value setting step (step S202) of setting by the weight calculator an initial value of the antenna weight in the antenna weighting unit; a first calculation step (step S204) of calculating the equalization weight by the weight calculator using an optimization algorithm in a state where the initial value is retained in the antenna weighting unit, the optimization algorithm minimizing the error; a second calculation step (step S205) of calculating the antenna weight by the weight calculator using the optimization algorithm in a state where the equalization weight calculated in the first calculation step is retained in the adaptive equalizer; and a third calculation step (step S204) of calculating the equalization weight by the weight calculator using the optimization algorithm in a state where the antenna weight calculated in the second calculation step is retained in the antenna weighting unit.

A tenth aspect of the present invention is summarized as a reception method using: an array antenna having a plurality of antenna elements; an antenna weighting unit configured to weight reception signals received by the array antenna; an adaptive equalizer configured to equalize the reception signals weighted by the antenna weighting unit; and a weight calculator configured to calculate an antenna weight to be set in the antenna weighting unit and an equalization weight to be set in, the adaptive equalizer in accordance with an error between an output signal from the adaptive equalizer and a predetermined reference signal, the method comprising: an initial value setting step (step S102) of setting by the weight calculator an initial value of the equalization weight in the adaptive equalizer; a first calculation step (step S104) of calculating the antenna weight by the weight calculator using an optimization algorithm in a state where the initial value is retained in the adaptive equalizer, the optimization algorithm minimizing the error; a second calculation step (step S105) of calculating the equalization weight by the weight calculator using the optimization algorithm in a state where the antenna weight calculated in the first calculation step is retained in the antenna weighting unit; and a third calculation step (step S104) of calculating the antenna weight by the weight calculator using the optimization algorithm in a state where the equalization weight calculated in the second calculation step is retained in the adaptive equalizer.

According to the present invention, it is possible to provide a receiver, a radio base station, and a reception method which allow properly calculating an antenna weight and an equalization weight by use of an optimization algorithm even with the configuration in which an adaptive equalizer is series-connected to an output of an adaptive array antenna.

### BRIEF DESCRIPTION OF THE DRAWINGS

FIG. 1 is a schematic configuration diagram of a radio communication system to which a radio base station according to an embodiment of the present invention is applied.

FIG. 2 is a functional block diagram of a receiver according to the embodiment of the present invention.

FIG. 3 is a flowchart showing Operation Pattern 1 of the receiver according to the embodiment of the present invention.

FIG. 4 is a flowchart showing Operation Pattern 2 of the receiver according to the embodiment of the present invention.

FIG. 5 is a partial configuration diagram of the receiver according to the embodiment of the present invention.

FIG. 6 is another partial configuration diagram of the receiver according to the embodiment of the present invention.

FIG. 7 is a flowchart showing an operation of a receiver according to another embodiment of the present invention.

### BEST MODE FOR CARRYING OUT THE INVENTION

Next, embodiments of the present invention will be described hereinafter with reference to the drawings. In the following description of the drawings in the embodiments, the same or similar reference numerals are given to the same or similar parts.

Hereinafter, descriptions will be given of (1) Schematic Configuration of Radio Communication System, (2) Configuration of Radio Base Station, (3) Schematic Operation of Receiver, (4) Weight Calculation Algorithm, (5) Advantages and Effects, and (6) Other Embodiments.

### (1) Schematic Configuration of Radio Communication System

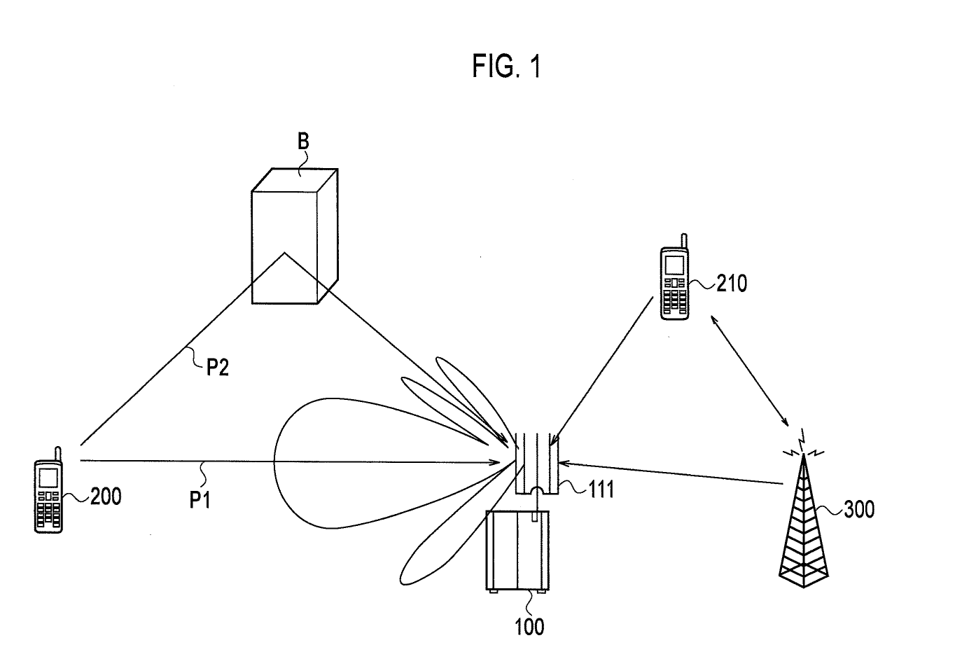

Firstly, with reference to FIG. 1, a description will be given of a schematic configuration of a radio communication system to which a radio base station 100 according to this embodiment is applied. The radio communication system shown in FIG. 1 has the radio base station 100, a radio base station 300, a radio communication terminal 200 and a radio communication terminal 210.

The radio base station 100 and the radio communication terminal 200 perform radio communications based on IEEE 802.16c (WiMAX (registered trademark)) or iBurst (registered trademark) (for iBurst, refer to “High Capacity-Spatial Division Multiple Access (HC-SDMA),” WTSC-2005-032, ATIS/ANSI).

On the other hand, the radio base station 300 and the radio communication terminal 210 are compliant with a radio communication system which is different from or the same as that of the radio base station 100 and the radio communication terminal 200. Since radio signals are also emitted from the radio base station 300 and the radio communication terminal 210, the radio base station 100 receives not only desired waves from the radio communication terminal 200 but also interference waves from the radio base station 300 and the radio communication terminal 210.

The radio base station 100 includes an array antenna 111 and performs adaptive array control using the array antenna 111. Specifically, the radio base station 100 communicates with the radio communication terminal 200 while setting the directivity of the array antenna 111 toward the radio communication terminal 200, thereby increasing the antenna gain for the desired waves from the radio communication terminal 200.

In addition, the radio base station 100 directs a null point in the directions of the radio communication terminal 210 and the radio base station 300 so as to decrease the directivity of the array antenna 111. The radio base station 100 thereby decreases the antenna gain for the interference waves from the radio communication terminal 210 and the radio base station 300.

A radio signal transmitted from the radio communication terminal 200 is received by the radio base station 100 via a path P1 through which the radio signal directly reaches the radio base station 100, and via a path P2 through which the radio signal reaches the radio base station 100 after reflected by a building B or the like.

In other words, the radio signal received by the radio base station 100 via the path P1 is a preceding wave (direct wave); the radio signal received by the radio base station 100 via the path P2 is a delay wave.

Due to influence of the delay wave, the reception signal received by the radio base station 100 is distorted. For this reason, the radio base station 100 corrects the distortion by adaptively equalizing the reception signal.

The radio signal transmitted by the radio communication terminal 200 includes a known signal series (hereinafter, referred to as a known signal). In addition, the radio base station 100 stores therein a reference signal that is a signal series equivalent to the known signal.

In other words, the radio base station 100 executes adaptive array control and adaptive equalization control so as to minimize an error between the known signal and the reference signal. The radio base station 100 is thus capable of achieving communications suitable for the radio communication environment.

### (2) Configuration of Radio Base Station 100

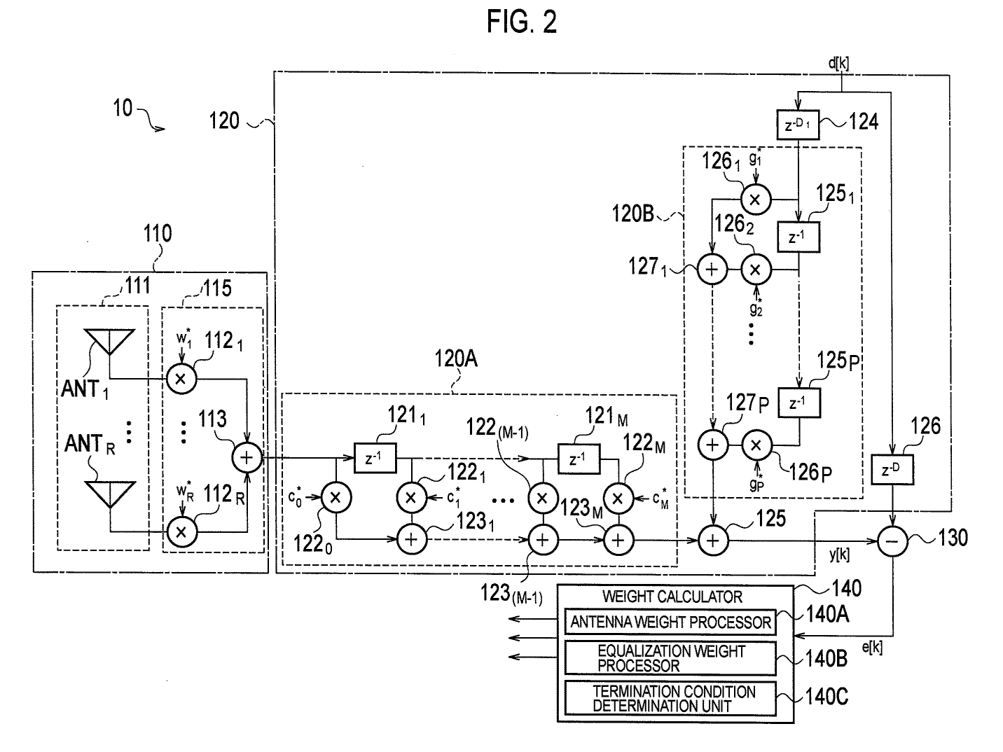

Next, with reference to FIG. 2, a description will be given of a configuration of a receiver 10 provided in the radio base station 100. As shown in FIG. 2, the receiver 10 has an adaptive array antenna 110, an adaptive equalizer 120, a subtractor 130 and a weight calculator 140.

The adaptive array antenna 110 performs the adaptive array control using the array antenna 111. The adaptive equalizer 120 delays a reception signal multiple times and also weights each of the delayed reception signals.

The subtractor 130 calculates an error signal e[k] that indicates an error between an output signal y[k] of the adaptive equalizer 120 and a reference signal d[k]. The weight calculator 140 calculates an antenna weight and an equalization weight in accordance with the error signal e[k] during a training period (known signal period).

(2.1) Configuration of Adaptive Array Antenna 110

The adaptive array antenna 110 has the array antenna 111 and an antenna weighting unit 115. The array antenna 111 has antenna elements ANT₁ to ANT_{R}.

The antenna weighting unit 115 has complex multipliers 112₁ to 112_{R} and an adder 113. The complex multipliers 112₁ to 112_{R} are provided for the respective antenna elements ANT₁ to ANT_{R}. The complex multipliers 112₁ to 112_{R} weight the reception signals by use of antenna weights w*₁ to w*_{R}, the reception signals received by the antenna elements ANT₁ to ANT_{R}, respectively.

The reception signals are multiplied by the antenna weights w*₁ to w*_{R}, so that the amplitudes and the phases of the reception signals received by the antenna elements ANT₁ to ANT_{R} are controlled. The adder 113 combines the reception signals weighted by the respective complex multipliers 112₁ to 112_{R}.

(2.2) Configuration of Adaptive Equalizer 120

The adaptive equalizer 120 has a feedforward unit 120A, a feedback unit 120B, delay elements 124 and 126 and an adder 125. Here, a decision unit an illustration of which is omitted makes a symbol decision for the output signal y[k] of the adaptive equalizer 120.

The feedforward unit 120A has a function to match the phases of a preceding wave component and a delay wave component of a reception signal. The feedback unit 120B serves as a decision feedback equalizer (DFE) that feeds back the decision symbol obtained by the decision unit. The feedback unit 120B receives the reference signal d[k] during the training period.

The feedforward unit 120A is configured as a FIR (Finite Impulse Response) filter and is connected to an output side of the adaptive array antenna 110. Specifically, the feedforward unit 120A has delay elements 121₁ to 121_{M}, complex multipliers 122₀ to 122_{M} and adders 123₁ to 123_{M}.

The delay elements 121₁ to 121_{M} are connected in series and delay the reception signal. The complex multipliers 122₀ to 122_{M} multiply the output signals from the respective delay elements 121₁ to 121_{M} by equalization weights c*₀ to c*_{M}. The output signals are multiplied by the equalization weights c*₀ to c*_{M} so that the amplitude and phase of each of the output signals from the delay elements 121₁ to 121_{M} can be controlled. The adders 123₁ to 123_{M} combine the output signals from the complex multipliers 122₀ to 122_{M}.

The feedback unit 120B has delay elements 125₁ to 125_{P}, complex multipliers 126₁ to 126_{P} and adders 127₁ to 127ₚ.

The delay elements 125₁ to 125_{P} are connected in series and delay the reference signal d[k]. The complex multipliers 126₁ to 126_{P} multiply output signals from the respective delay elements 125₁ to 125_{P} by weights g*₁ to g*_{P}. The adders 127₁ to 127_{P} combine the output signals from the complex multipliers 126₁ to 126_{P}.

The adder 125 combines the output signal of the feedforward unit 120A and the output signal of the feedback unit 120B. The output signal y[k] of the adder 125 is inputted to the subtractor 130. The subtractor 130 generates the error signal e[k] between the reference signal d[k] and the output signal y[k].

(2.3) Configuration of Weight Calculator 140

Next, a description will be given of the weight calculator 140. Here, the points related to the present invention will be mainly described below.

The weight calculator 140 has an antenna weight processor 140A, an equalization weight processor 140B and a termination condition determination unit 140C.

The antenna weight processor 140A mainly performs the following (a1) to (a3).

(a1) Function to set a fixed value C*_{w} in any of the antenna weights w*₁ to w*_{R}.

(a2) Function to set an initial value in each of the antenna weights w*₁ to w*_{R}.

(a3) Function to calculate the antenna weights w*₁ to w*_{R} by use of an optimization algorithm on the basis of the error signal e[k]. In this embodiment, the minimum mean square error (MMSE) model is used as the optimization algorithm.

The equalization weight processor 140B mainly performs the following (b1) to (b3).

(b1) Function to set a fixed value C*_{c} in any of the equalization weights c*₀ to c*_{M}.

(b2) Function to set an initial value in each of the equalization weights c*₀ to c*_{M}.

(b3) Function to calculate the equalization weights c*₀ to c*_{M} by use of the optimization algorithm on the basis of the error signal e[k].

The termination condition determination unit 140C determines whether or not the number of repetitions 1 of the antenna weights w*₁ to w*_{R} by the antenna weight processor 140A and the number of repetitions l of the equalization weights c*₀ to c*_{M} by the equalization weight processor 140B have reached a required number of repetitions lₘₐₓ.

When the number of repetitions 1 reaches the required number of repetitions lₘₐₓ, the termination condition determination unit 140C stops the calculation of the antenna weights w*₁ to w*_{R} by the antenna weight processor 140A and the calculation of the equalization weights c*₀ to c*_{M} by the equalization weight processor 140B.

(2.4) Initial Value Setting Processing

Next, a description will be given of initial value setting processing to be executed by the weight calculator 140.

(2.4.1) Process for Setting Initial Values of Antenna Weights

The conceivable simplest method of setting the initial values of the antenna weights w*₁ to w*_{R} is the setting of the same value wᵣ₀ in all of the antenna weights w*₁ to w*_{R}.

However, the initial values of the antenna weights w*₁ to w*_{R} have an influence on the time required for the optimization of the antenna weights w*₁ to w*_{R} and the equalization weights c*₀ to c*_{M}. In other words, if the initial values of the antenna weights w*₁ to w*_{R} are properly set, the error signals e[k] can converge in a short time.

In this respect, the weight calculator 140 calculates the initial values of the antenna weights w*₁ to w*_{R} by the following technique in order to cause the error signals e[k] to converge in a short time.

Specifically, when calculating the initial values of the antenna weights w*₁ to w*_{R}, the weight calculator 140 performs control such that the output signal of the antenna weighting unit 115 can pass through the feedfoward unit 120A without being processed.

Specifically, the equalization weight processor 140B sets the equalization weight c*₀, which is to be inputted to the complex multiplier 122₀ among the complex multipliers 122₀ to 122_{M} of the feedfoward unit 120A, to “1,” and sets the other equalization weights c*₁ to c*_{M} to “0.”

The setting of the equalization weight c*₀, which is to be inputted to the complex multiplier 122₀, to “1” allows the signal before passing through the delay elements 121₁ to 121_{M} to pass through the complex multiplier 122₀ while the phase and amplitude thereof is not controlled. In addition, the setting of the other equalization weights c*₁ to c*_{M} to “0” prevents the signal that has passed through the delay elements 121₁ to 121_{M} from passing through the complex multipliers 122₁ to 122_{M}.

As a result, the output signal of the antenna weighting unit 115 can be set to a state where the output signal does not change at all in the feedforward unit 120A. In this state, the antenna weight processor 140A calculates the initial values of the antenna weights w*₁ to w*_{R} by use of the optimization algorithm.

(2.4.2) Process for Setting Initial Values of Equalization Weights

The conceivable simplest method of setting the initial values of the equalization weights c*₀ to c*_{M} is the setting of the same value cₘ₀ in all of the equalization weights c*₀ to c*_{M}.

However, the initial values of the equalization weights c*₀ to c*_{M} have an influence on the time required for the optimization of the antenna weights w*₁ to w*_{R} and the equalization weights c*₀ to c*_{M}. In other words, if the initial values of the equalization weights c*₀ to c*_{M} are properly set, the error signals e[k] can converge in a short time.

In this respect, the weight calculator 140 calculates the initial values of the equalization weights c*₀ to c*_{M} by one of the following techniques (a) and (b) in order to cause the error signals e[k] to converge in a short time.

(a) The weight calculator 140 calculates the initial values of the antenna weights w*₁ to w*_{R} by the technique described in (2.4.1). Then, the equalization weight processor 140B calculates the initial values of the equalization weights c*₀ to c*_{M} by use of the optimization algorithm in a state where the calculated initial values of the antenna weights w*₁ to w*_{R} are retained in the antenna weighting unit 115.

(b) The weight calculator 140 sets any one of the antenna weights w*₁ to w*_{R} to “1,” and sets all of the remaining weights to “0.” Thereby, the adaptive array antenna 110 can be deemed as a non-directivity antenna. In this state, the equalization weight processor 140B calculates the initial values of the equalization weights c*₀ to c*_{M} by use of the optimization algorithm.

### (3) Schematic Operation of Receiver 10

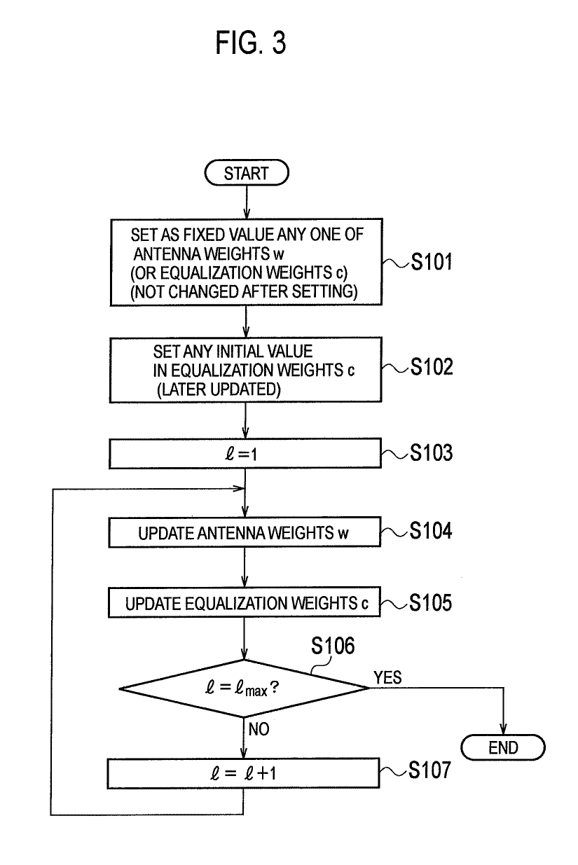

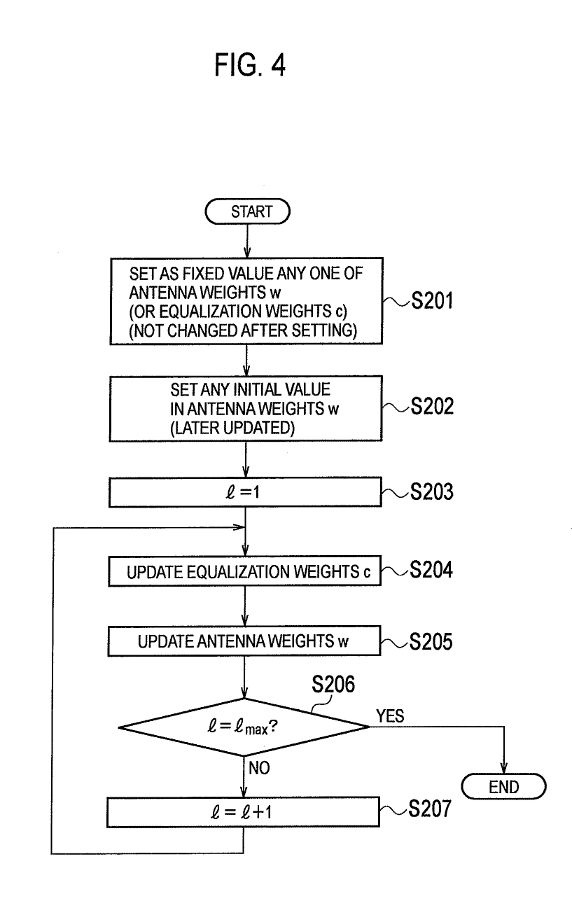

Next, a description will be given of a schematic operation of the receiver 10 with reference to FIGS. 3 and 4. Specifically, Operation Patterns 1 and 2 of the receiver 10 will be described.

(3.1) Operation Pattern 1 of Receiver 10

FIG. 3 is a flowchart showing Operation Pattern 1 of the receiver 10.

In step S101, the antenna weight processor 140A or the equalization weight processor 140B sets a fixed value in any one of the antenna weights w*₁ to w*_{R} or any one of the equalization weights c*₀ to c*_{M}. Here, it should be noted that, the fixed value is not updated after step S101.

In step S102, the equalization weight processor 140B sets an initial value in the equalization weights c*₀ to c*_{M}. Here, it should be noted that, the initial value is updated after step S102.

In step S103, the termination condition determination unit 140C sets l in the count value of the number of repetitions.

In step S104, the antenna weight processor 140A calculates the antenna weights w*₁ to w*_{R}. Then, the antenna weight processor 140A sets the calculated antenna weights w*₁ to w*_{R} in the complex multipliers 112₁ to 112_{R}, respectively.

In step S105, the equalization weight processor 140B calculates the equalization weights c*₀ to c*_{M}. The equalization weight processor 140B sets the calculated equalization weights c*₀ to c*_{M} in the complex multipliers 122₀ to 122_{M}, respectively.

In step S106, the termination condition determination unit 140C determines whether or not the number of repetitions 1 has reached the required number of repetitions lₘₐₓ. If it is determined that the number of repetitions l has reached the required number of repetitions lₘₐₓ, the weight calculation processing is terminated. The required number of repetitions lₘₐₓ can be set to around 10 times, for example.

Meanwhile, if it is determined that the number of repetitions l has not reached the required number of repetitions lₘₐₓ the processing proceeds to step S107. In step S107, the termination condition determination unit 140C adds 1 to the number of repetitions. Thereafter, the processing returns to step S104.

(3.2) Operation Pattern 2 of Receiver 10

FIG. 4 is a flowchart showing Operation Pattern 2 of the receiver 10.

The processing in step 201 is the same as that in step S101.

In step S202, the antenna weight processor 140A sets an initial value in the antenna weights w*₁ to w*_{R}. Here, it should be noted that, the initial value is updated after step S202.

In step S203, the equalization weight processor 140B sets 1 in a variable l for counting the number of calculations.

In step S204, the equalization weight processor 140B calculates the equalization weights c*₀ to c*_{M}. The equalization weight processor 140B sets the calculated equalization weights c*₀ to c*_{M} in the complex multipliers 122₀ to 122_{M}, respectively.

In step S205, the antenna weight processor 140A calculates the antenna weights w*₁ to w*_{R}. Then, the antenna weight processor 140A sets the calculated antenna weights w*₁ to w*_{R} in the complex multipliers 112₁ to 112_{R}, respectively.

In step S206, the termination condition determination unit 140C determines whether or not the number of repetitions 1 has reached the required number of repetitions lₘₐₓ. If it is determined that the number of repetitions l has reached the required number of repetitions lₘₐₓ, the weight calculation processing is terminated.

Meanwhile, if it is determined that the number of repetitions l has not reached the required number of repetitions lₘₐₓ, the processing proceeds to step S207. In step S207, the termination condition determination unit 140C adds 1 to the number of repetitions l. Thereafter, the processing returns to step S204.

### (4) Weight Calculation Algorithm

Next, a description will be given of a calculation algorithm for the antenna weights w*₁ to w*_{R} and the equalization weights c*₀ to c*_{M}.

(4.1) Summary of Algorithm

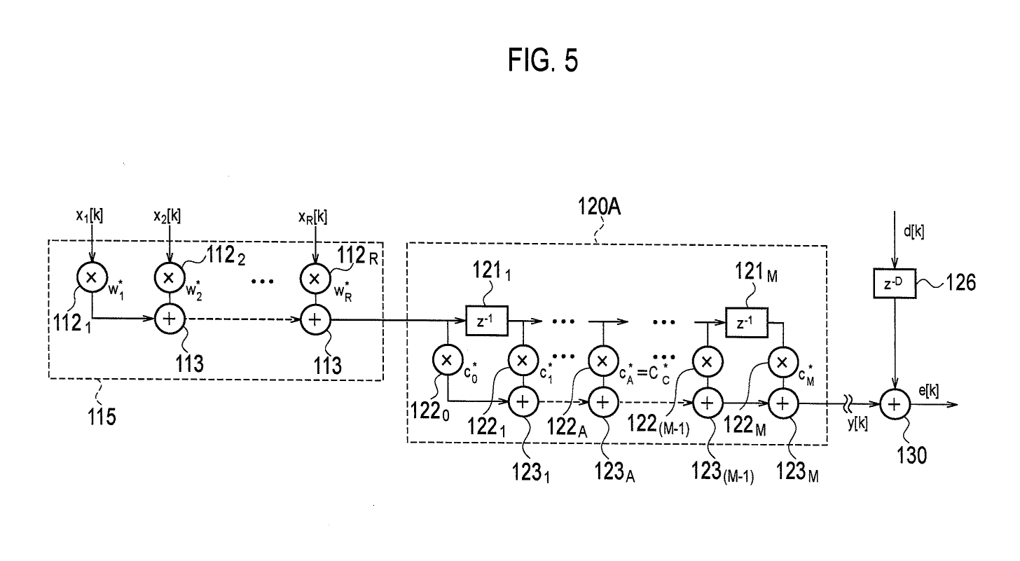

As shown in FIG. 5, each weight value to be set in the antenna weighting unit 115 is defined by w*ᵣ (1≦r≦R). Each weight value to be set in the feedforward unit 120A is defined by c*ₘ (0≦m≦M). An input signal to the antenna weighting unit 115 is defined by xᵣ[k].

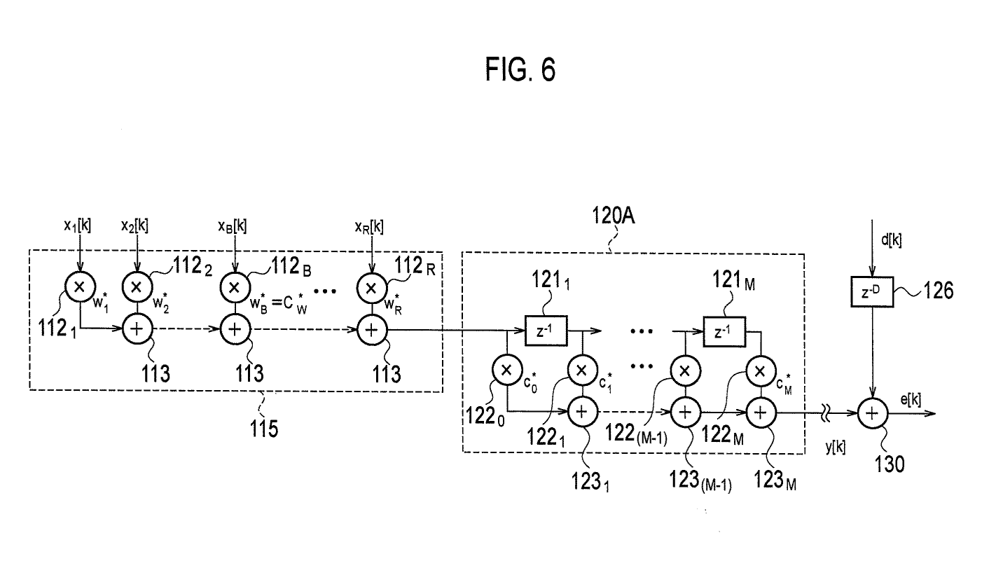

In FIG. 5, in order to avoid ambiguity of the antenna weights w*₁ to w*_{R} and the equalization weights c*₀ to c*_{M}, a weight value c*_{A} among the equalization weights c*₀ to c*_{M} is set to the fixed value C*_{c} (0≦A≦M). Alternatively, as shown in FIG. 6, a weight value w*_{B} among the antenna weights w*₁ to w*_{R} is set to the fixed value C*_{w} (0≦B≦M).

As shown below, the error signal e[k] is obtained by subtracting the output signal y[k] of the feedforward unit 120A from the reference signal d[k] (or d[k−D] obtained by delaying the reference signal d[k]) (0≦D≦M).

[Equation 1]

e[k]=d[k−D]−y[k] (1)

The aforementioned weight value to be set in the feedback unit 120B is defined by g*_{P} (0≦p≦P). In addition, the transfer function of the feedback unit 120B is expressed by the following equation (2):

G(z)=g₁z⁻¹+ . . . +gₚZ^{-P} (2).

The reference signal d[k] delayed by the delay element 124 is inputted to the feedback unit 120B. The output signal of the feedback unit 120B is added to the output signal of the feedforward unit 120A.

Hereinafter, not only the antenna weight value w*ᵣ and the equalization weight value c*ₘ are calculated, but also the weight value g*_{P} are calculated with the antenna weight value w*ᵣ and the equalization weight value c*ₘ.

The error signal e[k] is expressed by the following equation (3). Here, in the equations below, (•)^{H} indicates Hermitian transposition and <•> indicates a prediction operator.

$$\begin{matrix}[ Equation 2 ] & \\ e [ k ] = d [ k - D ] - [ \begin{matrix}{b}^{H} & {g}^{H}\end{matrix} ] [ \begin{matrix}ξ [ k ] \\ {d}_{G} [ k ]\end{matrix} ] & ( 3 ) \\ [ Equation 3 ] & \\ ξ [ k ] = {[ {x}_{1}^{T} [ k ] … {x}_{R}^{T} [ k ] ]}^{T} & ( 4 ) \\ [ Equation 4 ] & \\ {x}_{i}^{T} [ k ] = [ {x}_{i} [ k ] {x}_{i} [ k - 1 ] … {x}_{i} [ k - M ] ] 1 \leq i \leq R & ( 5 ) \\ [ Equation 5 ] & \\ {d}_{G} [ k ] = {[ d [ k - {D}_{1} ] … d [ k - {D}_{1} - P + 1 ] ]}^{T} & ( 6 )\end{matrix}$$

Here, if the weight value c*_{A} is set to the fixed value C*_{c} in the feedforward unit 120A, a vector b is:

b=[w₁c₀, . . . , w₁c_{A-1},w₁C_{c}, . . . w₁c_{M}, . . . ; w_{R}c₀, . . . , w_{R}c_{A-1},w_{R}C_{c}, . . . w_{R}c_{M}]^{T} [Equation 6]

(7). Alternatively, if a tensor product operator is used, the vector b is:

b=w [symbol] c^{F} [Equation 7]

(8). Here,

w=[w₁ . . . w_{R}]^{T} [Equation 8]

c^{F}=[c₀ . . . c_{A-1}C_{c} . . . c_{M}]^{T} (9).

Meanwhile, if the weight value w*_{B} is set to the fixed value C*_{w} in the antenna weighting unit 115, the vector b is:

b=[w₁c₀ . . . w₁c_{M}, . . . ; w_{B-1}c₀ . . . w_{B-1}c_{M}; C_{w}c₀ . . . C_{W}c_{M}, . . . ; w_{R}c₀ . . . w_{R}c_{M}]^{T} [Equation 9]

(10). Alternatively, if a tensor product operator is used, the vector b is:

b=w^{F} [symbol] c [Equation 10]

(11). Here,

w^{F}=[w₁ . . . w_{B-1},C_{w}w_{B+1} . . . w_{R}]^{T} [Equation 11]

c=[c₀ . . . c_{M}]^{T}

(12). Further, the aforementioned g is defined as follows:

[Equation 12]

g=[g₁, . . . g_{P}]^{T}

Next, if the MMSE function is applied to Equation (3), the square error is:

$$\begin{matrix} [ Equation 13 ] & \\ 〈 {\vert e [ k ] \vert}^{2} 〉 = 〈 {\vert {d}_{k - D} \vert}^{2} 〉 - [ \begin{matrix}{b}^{H} & {g}^{H}\end{matrix} ] 〈 ⌊ \begin{matrix}ξ ⌊ k ⌋ \\ {d}_{G} [ k ]\end{matrix} ⌋ {d}^{*} [ k - D ] 〉 -- 〈 {d [ k - D ] [ \begin{matrix}ξ ⌊ k ⌋ \\ {d}_{G} [ k ]\end{matrix} ]}^{H} 〉 [ \begin{matrix}b \\ g\end{matrix} ] + [ \begin{matrix}{b}^{H} & {g}^{H}\end{matrix} ] 〈 {[ \begin{matrix}ξ ⌊ k ⌋ \\ {d}_{G} [ k ]\end{matrix} ] [ \begin{matrix}ξ ⌊ k ⌋ \\ {d}_{G} [ k ]\end{matrix} ]}^{H} 〉 [ \begin{matrix}b \\ g\end{matrix} ] . & ( 14 )\end{matrix}$$

(4.2) Details of Algorithm

Hereinafter, details of the algorithm will be described with the following four patterns.

Pattern 1: a pattern in which the antenna weights w*₁ to w*_{R} are initialized after the fixed value C*_{c} is set in the equalization weight value c*_{A}.

Pattern 2: a pattern in which the equalization weights c*₀ to c*_{M} are initialized after the fixed value C*_{c} is set in the equalization weight value c*_{A}.

Pattern 3: a pattern in which the antenna weights w*₁ to w*_{R} are initialized after the fixed value C*_{w} is set in the antenna weight w*_{B}.

Pattern 4: a pattern in which the equalization weights c*₀ to c*_{M} are initialized after the fixed value C*_{w} is set in the antenna weight value w*_{R}.

(4.2.1) Pattern 1

The algorithm in Pattern 1 is shown in Table 1.

TABLE 1

| initialise (l = 0) | $\begin{matrix}{c}_{A}^{*} = {C}_{c}^{*} \\ {w}_{0} = {w}_{O} {W}_{0} \cdot {{w}_{0}}^{⋒}\end{matrix}$ |
|---|---|
| l = 1 . . . lₘₐₓ | $\begin{matrix}[ \begin{matrix}{c}_{l} \\ {g}_{l}\end{matrix} ] = {( [ \begin{matrix}{W}_{l - 1} & 0 \\ 0 & I\end{matrix} ] R [ \begin{matrix}{W}_{l - 1}^{H} & 0 \\ 0 & I\end{matrix} ] )}^{- 1} ( [ \begin{matrix}{W}_{l - 1} & 0 \\ 0 & I\end{matrix} ] p - [ \begin{matrix}{W}_{l - 1} & 0 \\ 0 & I\end{matrix} ] R [ \begin{matrix}{{w}_{l - 1}}^{⋒} \\ 0\end{matrix} ] ) \\ {c}_{l} {C}_{l}\end{matrix}$ |
| | $\begin{matrix}[ \begin{matrix}{w}_{l} \\ {g}_{l}^{a}\end{matrix} ] = {( [ \begin{matrix}{C}_{l} & 0 \\ 0 & I\end{matrix} ] R [ \begin{matrix}{C}_{l}^{H} & 0 \\ 0 & I\end{matrix} ] )}^{- 1} [ \begin{matrix}{C}_{l} & 0 \\ 0 & I\end{matrix} ] p \\ {w}_{l} {W}_{l} \cdot {{w}_{l}}^{⋒}\end{matrix}$ |

The antenna weight value w*ᵣ, more specifically, a conjugate complex weight wᵣ in the number of repetitions l is as the vector below:

[Equation 14]

w₁=[w_{1,l},w_{2,l}, . . . w_{R,l}]^{T} for 0≦l≦lₘₐₓ (15).

The initial vector of w₁ is defined as follows:

[Equation 15]

w_{O}=[w_{O1},w_{O2}, . . . w_{OR}]^{T} (16).

A matrix W₁ is defined as follows:

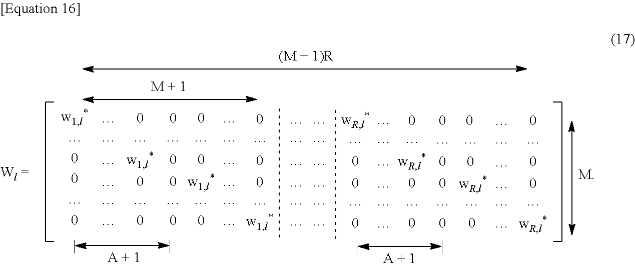

Alternatively, W₁ can be defined in the following manner by use of a tensor product operator:

$$\begin{matrix}[ Equation 17 ] & \\ {W}_{l} = {w}_{l}^{H} ⊗ I \frac{M + 1}{( A + 1 ) Row} . & ( 18 )\end{matrix}$$

In addition,

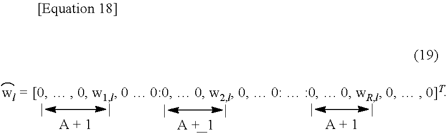

If a tensor product operator is used,

ŵₗ=w₁ [symbol] i_{A+1}^{M-1} [Equation 19]

(20). In addition,

cₗ=[c_{0,l}, . . . , C_{A-1,l}, C_{A+1,l}, . . . , C_{M,l}]^{T} [Equation 20]

(21), and

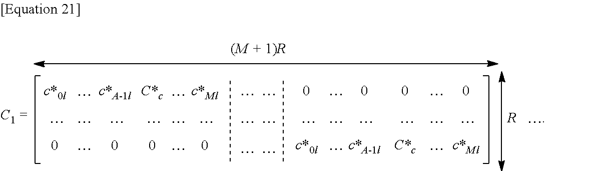

Alternatively, if a tensor product operator is used,

C₁=I^{R} [symbol] cₗ^{F}^{^{H}} [Equation 22]

(23). Here,

cₗ^{F}=[c_{0,l}, . . . , c_{A-1,l},C_{c},c_{A+1,l}, . . . , c_{M,l}]^{T} [Equation 23]

(24). In addition,

[Equation 24]

gₗ=[g_{1,l}, . . . , g_{P,l}]^{T}

gₗ^{a}=[g_{1,l}^{a}, . . . , g_{P,l}^{a}]^{T} (25).

Updated weight values g*_{p,l} and g^{a}*_{p,l} do not need to betaken over at the time of repetitions. Accordingly, the weight value g*ₚ may be calculated only at the last repetition of calculating the weight value w*ᵣ.

A correlation matrix R and a cross-correlation vector p are:

$$\begin{matrix}[ Equation 25 ] & \\ R = [ \begin{matrix}〈 ξ [ k ] {ξ}^{H} [ k ] 〉 & 〈 ξ [ k ] {d}_{G}^{H} [ k ] 〉 \\ 〈 {d}_{G} [ k ] {ξ}^{H} [ k ] 〉 & 〈 {d}_{G} [ k ] {d}_{G}^{H} [ k ] 〉\end{matrix} ] \\ p = 〈 [ \begin{matrix}ξ [ k ] \\ {d}_{G} [ k ]\end{matrix} ] {d}^{*} [ k - D ] 〉 . & ( 26 )\end{matrix}$$

In this algorithm, a correlation value of the correlation matrix and the cross-correlation vector is calculated by use of an input signal and a reference signal.

The initial value w₀, has a large influence on the adaptive rate. In an example of the initial value w₀, the same value is set in all of the values. Alternatively, provided that M=0 and c₀=1, the convergence can be faster. In this case, the initial value can be calculated in the following manner. To begin with,

$$\begin{matrix} [ Equation 26 ] & \\ [ \begin{matrix}{\tilde{w}}_{O} \\ {g}_{O}^{a}\end{matrix} ] = {( [ \begin{matrix}〈 χ [ k ] {χ}^{H} [ k ] 〉 & 〈 χ [ k ] {d}_{G}^{H} [ k ] 〉 \\ 〈 {d}_{G} [ k ] {χ}^{H} [ k ] 〉 & 〈 {d}_{G} [ k ] {d}_{G}^{H} [ k ] 〉\end{matrix} ] )}^{- 1} 〈 [ \begin{matrix}χ [ k ] \\ {d}_{G} [ k ]\end{matrix} ] {d}^{*} [ k - D ] 〉 . & ( 27 )\end{matrix}$$

Here,

x[k]=[x₁[k], . . . , x_{R}[k]] [Equation 27]

(28). In order to acquire a scaling factor, the following computation is required:

$$\begin{matrix} [ Equation 28 ] & \\ [ \begin{matrix}{\tilde{c}}_{O}^{F} \\ {g}_{O}\end{matrix} ] = {( [ \begin{matrix}〈 u [ k ] {u}^{H} [ k ] 〉 & 〈 u [ k ] {d}_{G}^{H} [ k ] 〉 \\ 〈 {d}_{G} [ k ] {u}^{H} [ k ] 〉 & 〈 {d}_{G} [ k ] {d}_{G}^{H} [ k ] 〉\end{matrix} ] )}^{- 1} 〈 [ \begin{matrix}u [ k ] \\ {d}_{G} [ k ]\end{matrix} ] {d}^{*} [ k - D ] 〉 ; & ( 29 ) \\ [ Equation 29 ] & \\ u [ k ] = {[ {\tilde{w}}_{O}^{H} \cdot χ [ k ] , … {\tilde{ w}}_{O}^{H} \cdot χ [ k - M ] ]}^{T} . & ( 30 )\end{matrix}$$

The scaling factor λ of the initial value w₀ is:

$$\begin{matrix}[ Equation 30 ] & \\ λ = \frac{{\tilde{c}}_{OA}^{F}}{{C}_{c}} . & ( 31 )\end{matrix}$$

Accordingly,

[Equation 31]

W_{O}=λ·\tilde{w}_{O} (32).

(4.2.2) Pattern 2

The algorithm in Pattern 2 is shown in Table 2.

TABLE 2

| initialise (l = 0) | $\begin{matrix}{c}_{A}^{*} = {C}_{c}^{*} \\ {c}_{0} = {c}_{O}\end{matrix} \} {C}_{0}$ |
|---|---|
| l = 1 . . . lₘₐₓ | $\begin{matrix}[ \begin{matrix}{w}_{l} \\ {g}_{l}^{a}\end{matrix} ] = {( [ \begin{matrix}{C}_{l} & 0 \\ 0 & I\end{matrix} ] R [ \begin{matrix}{C}_{l}^{H} & 0 \\ 0 & I\end{matrix} ] )}^{- 1} [ \begin{matrix}{C}_{l} & 0 \\ 0 & I\end{matrix} ] p \\ {w}_{l} {W}_{l} \cdot {{w}^{⋒}}_{l}\end{matrix}$ |
| | $\begin{matrix}[ \begin{matrix}{c}_{l} \\ {g}_{l}\end{matrix} ] = {( [ \begin{matrix}{W}_{l - 1} & 0 \\ 0 & I\end{matrix} ] R [ \begin{matrix}{W}_{l - 1}^{H} & 0 \\ 0 & I\end{matrix} ] )}^{- 1} ( [ \begin{matrix}{W}_{l - 1} & 0 \\ 0 & I\end{matrix} ] p - [ \begin{matrix}{W}_{l - 1} & 0 \\ 0 & I\end{matrix} ] R [ \begin{matrix}{{w}_{l - 1}}^{⋒} \\ 0\end{matrix} ] ) \\ {c}_{l} {C}_{l}\end{matrix}$ |

(4.2.3) Pattern 3

The algorithm in Pattern 3 is shown in Table 3.

TABLE 3

| initialise (l = 0) | $\begin{matrix}{w}_{B}^{*} = {C}_{w}^{*} \\ {w}_{0} = {w}_{O}\end{matrix} \} {W}_{0}$ |
|---|---|
| l = 1 . . . lₘₐₓ | $\begin{matrix}[ \begin{matrix}{c}_{l} \\ {g}_{l}\end{matrix} ] = {( [ \begin{matrix}{W}_{l - 1} & 0 \\ 0 & I\end{matrix} ] R [ \begin{matrix}{W}_{l - 1}^{H} & 0 \\ 0 & I\end{matrix} ] )}^{- 1} [ \begin{matrix}{W}_{l - 1} & 0 \\ 0 & I\end{matrix} ] p \\ {c}_{l} {C}_{l} \cdot {{c}_{l}}^{⋒}\end{matrix}$ |
| | $\begin{matrix}[ \begin{matrix}{w}_{l} \\ {g}_{l}^{a}\end{matrix} ] = {( [ \begin{matrix}{C}_{l} & 0 \\ 0 & I\end{matrix} ] R [ \begin{matrix}{C}_{l}^{H} & 0 \\ 0 & I\end{matrix} ] )}^{- 1} ( [ \begin{matrix}{C}_{l} & 0 \\ 0 & I\end{matrix} ] p - [ \begin{matrix}{C}_{l} & 0 \\ 0 & I\end{matrix} ] R [ \begin{matrix}{{c}_{l}}^{⋒} \\ 0\end{matrix} ] ) \\ {w}_{l} {W}_{l}\end{matrix}$ |

(4.2.4) Pattern 4

The algorithm in Pattern 4 is shown in Table 4.

TABLE 4

| initialise (l = 0) | $\begin{matrix}{w}_{B}^{*} = {C}_{w}^{*} \\ {c}_{0} = {c}_{O} {C}_{0}\end{matrix}$ |
|---|---|
| l = 1 . . . lₘₐₓ | $\begin{matrix}[ \begin{matrix}{w}_{I} \\ {g}_{l}^{a}\end{matrix} ] = {( [ \begin{matrix}{C}_{l} & 0 \\ 0 & I\end{matrix} ] R [ \begin{matrix}{C}_{l}^{H} & 0 \\ 0 & I\end{matrix} ] )}^{- 1} ( [ \begin{matrix}{C}_{l} & 0 \\ 0 & I\end{matrix} ] p - [ \begin{matrix}{C}_{l} & 0 \\ 0 & I\end{matrix} ] R [ \begin{matrix}{{c}_{l}}^{⋒} \\ 0\end{matrix} ] ) \\ {w}_{l} {W}_{l} \cdot {{w}_{l}}^{⋒}\end{matrix}$ |
| | $\begin{matrix}[ \begin{matrix}{c}_{l} \\ {g}_{l}\end{matrix} ] = {( [ \begin{matrix}{W}_{l - 1} & 0 \\ 0 & I\end{matrix} ] R [ \begin{matrix}{W}_{l - 1}^{H} & 0 \\ 0 & I\end{matrix} ] )}^{- 1} [ \begin{matrix}{W}_{l - 1} & 0 \\ 0 & I\end{matrix} ] p \\ {c}_{l} {C}_{l}\end{matrix}$ |

### (5) Effects and Advantages

According to this embodiment, the weight calculator 140 alternately calculates the antenna weights w*₁ to w*_{R} and the equalization weights c*₀ to c*_{M} instead of collectively calculating to the antenna weights w*₁ to w*_{R} and the equalization weights c*₀ to c*_{M}. In other words, it is possible to set the antenna weights w*₁ to w*_{R} not to change at the time of calculating the equalization weights c*₀ to c*_{M}, and also to set the equalization weights c*₀ to c*_{M} not to change at the time of calculating the antenna weights w*₁ to w*_{R}.

Accordingly, it is possible to provide the receiver 10 that is capable of properly calculating the antenna weights w*₁ to w*_{R} and the equalization weights c*₀ to c*_{M} by use of the optimization algorithm even with the configuration in which the adaptive equalizer 120 is series-connected to the output of the adaptive array antenna 110.

According to this embodiment, the antenna weight processor 140A iteratively calculates the antenna weights w*₁ to w*_{R} until the number of repetitions reaches the required number of repetitions lₘₐₓ. The equalization weight processor 140B iteratively calculates the equalization weights c*₀ to c*_{M} until the number of repetitions reaches the required number of repetitions lₘₐₓ.

Accordingly, the antenna weights w*₁ to w*_{R} and the equalization weights c*₀ to c*_{M} can be calculated with high accuracy.

According to this embodiment, through the initial value setting processing described in (2.4), the time required for optimizing the antenna weights w*₁ to w*_{R} and the equalization weights c*₀ to c*_{M} can be shortened.

### (6) Other Embodiments

Although the present invention has been described through the embodiment as described above, it should not be construed that the description and drawings constituting a part of this disclosure will limit the present invention. Various alternative embodiments, examples, and operation techniques will be apparent to those skilled in the art from this disclosure.

In the embodiment described above, the termination condition determination unit 140C terminates the weight calculation processing when the number of repetitions 1 of the antenna weights w*₁ to w*_{R} and the equalization weights c*₀ to c*_{M} reaches the required number of repetitions lₘₐₓ.

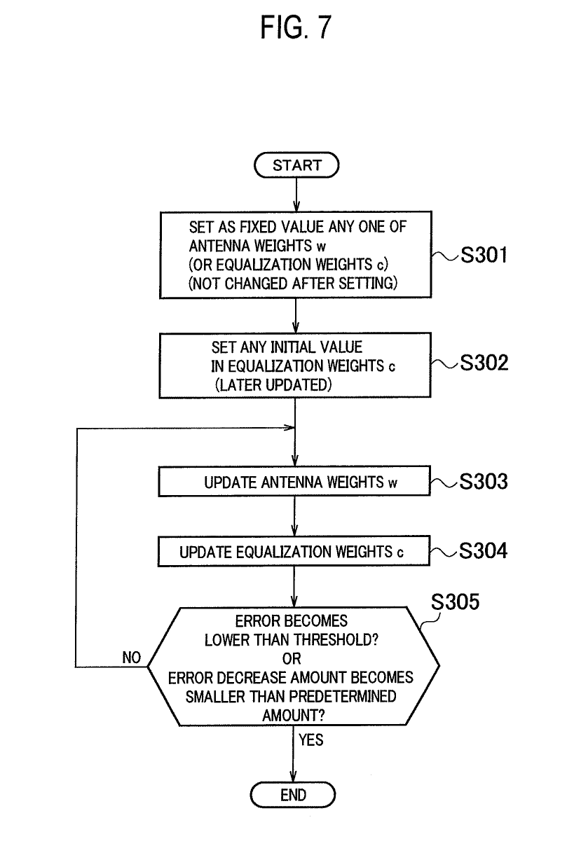

However, instead of the number of repetitions, another condition may be used as the termination condition of the weight calculation processing. FIG. 7 is a flowchart showing an operation of the receiver 10 when a condition other than the number of repetitions is used as the termination condition.

The flowchart shown in FIG. 7 is different from the flowchart shown in each of FIGS. 3 and 4 in that the required number of repetitions lₘₐₓ is not determined.

Instead, in step S305, the termination condition determination unit 140C determines whether or not the mean square error based on the error signal e[k] becomes lower than a predetermined threshold, or whether or not the amount of decrease of the mean square error based on the error signal e[k] becomes smaller than a predetermined amount.

Specifically, the termination condition determination unit 140C stops the calculation of the antenna weights w*₁ to w*_{R} by the antenna weight processor 140A and the calculation of the equalization weights c*₀ to c*_{M} by the equalization weight processor 140B when the mean square error based on the error signal e[k] becomes smaller than a predetermined threshold.

Alternatively, the termination condition determination unit 140C stops the calculation of the antenna weights w*₁ to w*_{R} by the antenna weight processor 140A and the calculation of the equalization weights c*₀ to c*_{M} by the equalization weight processor 140B when the amount of decrease of the mean square error based on the error signal e[k] becomes smaller than a predetermined amount.

In this manner, the repeat operation can be stopped immediately when the antenna weights w*₁ to w*_{R} and the equalization weights c*₀ to c*_{M} converge. Thus, the processing load of the weight calculator 140 can be reduced.

In this way, it should be understood that the present invention includes various embodiments or the like which have not been described herein. Therefore, the present invention shall be limited only by the specific subject matters of the invention according to the scope of claims which are reasonable from the disclosure.

Note that, the entire contents of Japanese Patent Application No. 2007-309496 (filed on Nov. 29, 2007) are incorporated herein by reference.

### INDUSTRIAL APPLICABILITY

As described above, the receiver, the radio base station, and the reception method according to the present invention are advantageous in radio communications such as mobile communications because the antenna weights and the equalization weights can be properly calculated by use of the optimization algorithm even with the configuration in which the adaptive equalizer is series-connected to the output of the adaptive array antenna.

1. A receiver comprising:
an array antenna having a plurality of antenna elements;
an antenna weighting unit configured to weight reception signals received by the array antenna;
an adaptive equalizer configured to equalize the reception signals weighted by the antenna weighting unit; and
a weight calculator configured to calculate an antenna weight to be set in the antenna weighting unit and an equalization weight to be set in the adaptive equalizer in accordance with an error between an output signal from the adaptive equalizer and a predetermined reference signal, wherein
the weight calculator comprises:
an initial value setting unit configured to set an initial value of the antenna weight in the antenna weighting unit;
a first equalization weight calculator configured to calculate the equalization weight by use of an optimization algorithm minimizing the error in a state where the initial value is retained in the antenna weighting unit;
an antenna weight calculator configured to calculate the antenna weight by use of the optimization algorithm in a state where the equalization weight calculated by the first equalization weight calculator is retained in the adaptive equalizer; and
a second equalization weight calculator configured to calculate the equalization weight by use of the optimization algorithm in a state where the antenna weight calculated by the antenna weight calculator is retained in the antenna weighting unit.

2. The receiver according to claim 1, wherein
the antenna weight calculator calculates the antenna weight by use of the optimization algorithm in a state where the equalization weight calculated by the second equalization weight calculator is retained in the adaptive equalizer,
the second equalization weight calculator iteratively calculates the equalization weight until the number of calculations reaches a predetermined number of times, and
the antenna weight calculator iteratively calculates the antenna weight until the number of calculations reaches a predetermined number of times.

3. The receiver according to claim 1, further comprising:
a threshold comparator configured to compare the error with a threshold; and
a calculation termination unit configured to terminate the calculation of the antenna weight in the weight calculator and the calculation of the equalization weight in the weight calculator when the error becomes lower than the threshold.

4. The receiver according to claim 1, further comprising:
a first detector configured to detect a first error decrease amount by which the error is decreased because the antenna weight is set in the antenna weighting unit;
a second detector configured to detect a second error decrease amount by which the error is decreased because the equalization weight is set in the adaptive equalizer; and
a calculation terminating unit configured to terminate the calculation of the antenna weight in the weight calculator and the calculation of the equalization weight in the weight calculator when any one of the first error decrease amount and the second error decrease amount becomes lower than a predetermined amount.

5. The receiver according to claim 1, further comprising a fixed value setting unit configured to set as a fixed value any one of a plurality of weight values forming the antenna weight; or any one of a plurality of weight values forming the equalization weight, before the initial value is set.

6. The receiver according to claim 1, wherein the initial value setting unit calculates the initial value of the antenna weight by use of the optimization algorithm in a state where an output signal of the antenna weighting unit passes through the adaptive equalizer without being processed, and then sets the calculated initial value in the antenna weighting unit.

7. A receiver comprising:
an array antenna having a plurality of antenna elements;
an antenna weighting unit configured to weight reception signals received by the array antenna;
an adaptive equalizer configured to equalize the reception signals weighted by the antenna weighting unit; and
a weight calculator configured to calculate an antenna weight to be set in the antenna weighting unit and an equalization weight to be set in the adaptive equalizer in accordance with an error between an output signal from the adaptive equalizer and a predetermined reference signal, wherein
the weight calculator comprises:
an initial value setting unit configured to set an initial value of the equalization weight in the adaptive equalizer;
a first antenna weight calculator configured to calculate the antenna weight by use of an optimization algorithm minimizing the error in a state where the initial value is retained in the adaptive equalizer;
an equalization weight calculator configured to calculate the equalization weight by use of the optimization algorithm in a state where the antenna weight calculated by the first antenna weight calculator is retained in the antenna weighting unit; and
a second antenna weight calculator configured to calculate the antenna weight by use of the optimization algorithm in a state where the equalization weight calculated by the equalization weight calculator is retained in the adaptive equalizer.

8. A radio base station comprising the receiver according to Claim 1.

9. A reception method using:
an array antenna having a plurality of antenna elements;
an antenna weighting unit configured to weight reception signals received by the array antenna;
an adaptive equalizer configured to equalize the reception signals weighted by the antenna weighting unit; and
a weight calculator configured to calculate an antenna weight to be set in the antenna weighting unit and an equalization weight to be set in the adaptive equalizer in accordance with an error between an output signal from the adaptive equalizer and a predetermined reference signal,
the method comprising:
an initial value setting step of setting by the weight calculator an initial value of the antenna weight in the antenna weighting unit;
a first calculation step of calculating the equalization weight by the weight calculator using an optimization algorithm in a state where the initial value is retained in the antenna weighting unit, the optimization algorithm minimizing the error;
a second calculation step of calculating the antenna weight by the weight calculator using the optimization algorithm in a state where the equalization weight calculated in the first calculation step is retained in the adaptive equalizer; and
a third calculation step of calculating the equalization weight by the weight calculator using the optimization algorithm in a state where the antenna weight calculated in the second calculation step is retained in the antenna weighting unit.

10. A reception method using:
an array antenna having a plurality of antenna elements;
an antenna weighting unit configured to weight reception signals received by the array antenna;
an adaptive equalizer configured to equalize the reception signals weighted by the antenna weighting unit; and
a weight calculator configured to calculate an antenna weight to be set in the antenna weighting unit and an equalization weight to be set in the adaptive equalizer in accordance with an error between an output signal from the adaptive equalizer and a predetermined reference signal,
the method comprising:
an initial value setting step of setting by the weight calculator an initial value of the equalization weight in the adaptive equalizer;
a first calculation step of calculating the antenna weight by the weight calculator using an optimization algorithm in a state where the initial value is retained in the adaptive equalizer, the optimization algorithm minimizing the error;
a second calculation step of calculating the equalization weight by the weight calculator using the optimization algorithm in a state where the antenna weight calculated in the first calculation step is retained in the antenna weighting unit; and
a third calculation step of calculating the antenna weight by the weight calculator using the optimization algorithm in a state where the equalization weight calculated in the second calculation step is retained in the adaptive equalizer.

11. A radio base station comprising the receiver according to claim 2.

12. A radio base station comprising the receiver according to claim 3.

13. A radio base station comprising the receiver according to claim 4.

14. A radio base station comprising the receiver according to claim 5.

15. A radio base station comprising the receiver according to claim 6.

16. A radio base station comprising the receiver according to claim 7.
